(19) United States
(12) Patent Application Publication
(10) Pub. No.: US 2004/0074716 A1
(43) Pub. Date: Apr. 22, 2004

(54) Caliper brake cover for use with a motor vehicle wheel

(75) Inventors: Merle T. Brumfield, Tipp City, OH (US); Carol Gardner, Lewisburg, OH (US); Gerald Roberts, Middletown, OH (US); Cheyney White, Union, OH (US); Vance Winkler, Trotwood, OH (US)

Correspondence Address: Alan F. Meckstroth, JACOX, MECKSTROTH & JENKINS, Suite 2, 2310 Far Hills Building, Dayton, OH, 45419-1575, US

(73) Assignee: Harco Industries, Inc.

(21) Appl. No.: 10/601,739

(22) Filed: Jun. 23, 2003

Related U.S. Application Data
(63) Continuation-in-part of application No. 29/167,338, filed on Sep. 13, 2002, now Pat. No. D476275.

(51) Int. Cl. F16D 65/12

(52) U.S. Cl. 188/218 A

(57) ABSTRACT

A caliper brake housing cover is positioned in back of a cast metal motor vehicle wheel having large openings. The cover includes a body formed of sheet metal or other rigid material and having a generally flat arcuate front wall integrally connected to an arcuate outer rim wall. A set of tabs project inwardly from opposite end portions of the outer rim wall and have holes for receiving threaded fasteners for conveniently securing the cover to the caliper brake housing or other vehicle component. The cover may be plated or coated and/or decorated according to the color of the vehicle and helps to reduce a build-up of brake dust on the cast wheel in addition to enhancing the appearance of the wheel and brake housing.

### BACKGROUND OF THE INVENTION

In the construction of many motor vehicles and especially sport vehicles, it is common to use wheel assemblies which include rubber tires mounted on cast metal and chrome plated wheels having relatively large circumferentially spaced openings. It is also common for the vehicles to have caliper brake assemblies or units which have brake housings located axially inwardly of the wheels and which receive corresponding brake rotor discs mounted for rotation with the wheels. It is desirable for the wheel openings to be relatively large in order to minimize weight of the wheel and to provide for effective circulation of cooling air through the wheel and around the brake rotor disc and housing of the caliper brake assembly. Since the caliper brake housings are commonly produced as cast metal parts or components with spaced cooling fins, the brake housings provide an undesirable and unattractive appearance when viewed through the wheel openings.

While caliper brake housings are sometimes painted or powder coated black or with another color, the appearance of the brake housing through the wheel openings is still undesirable and downgrades the aesthetic appearance of the cast metal wheel which is usually chrome plated. It is also known to use metal cover discs or circular dust covers between a vehicle wheel and a caliper brake and rotor assembly, for example, as disclosed in U.S. Pat. No. 4,484,667 and No. 6,371,569. While such covers block the view of the caliper brake through any wheel openings, they substantially reduce the flow of cooling air through cast metal wheel openings. Wheel covers also have been used or proposed for use on motorcycles, for example, as disclosed in U.S. Pat. No. 4,744,606.

### SUMMARY OF THE INVENTION

The present invention is directed to a caliper brake cover which is ideally suited for use on a motor vehicle in back of a cast metal decorative wheel having large circumferentially spaced openings. The cover improves the aesthetic appearance of the wheel and brake assembly by providing the caliper brake housing with a clean and neat appearance as viewed through the openings within the wheel. The caliper brake housing cover of the invention also provides for reducing a buildup of brake dust on the cast wheel within the openings and may be custom painted or coated or decorated according to the color and/or type of motor vehicle. The caliper brake cover also does not block the flow of air through the wheel openings for cooling the brake rotor and housing. In addition, the caliper brake cover of the invention may be quickly and conveniently attached to the caliper brake housing or other vehicle component and may be easily removed for servicing the caliper brake. The caliper brake cover may also provide for reducing the temperature of the caliper brake and rotor disc by channeling a flow of air around the housing and rotor.

The above advantages of a caliper brake cover constructed in accordance with the invention are generally provided in accordance with a preferred embodiment of the invention by forming or stamping a sheet metal such as aluminum to form a generally flat and radially extending arcuate front wall integrally connected to a laterally extending and generally arcuate outer rim wall. A set of integral support tabs project from opposite end portions of the outer rim wall and have openings for mounting the cover on the caliper brake housing or on an adjacent component of the vehicle. The front wall and the outer rim wall cover the caliper brake housing with the front wall disposed between the brake housing and the inner surface of the cast metal wheels. The caliper brake cover may be chrome plated or painted or powder coated with a color which is the same or compatible with the color of the motor vehicle body.

Other features and advantages of the invention will be apparent from the following description, the accompanying drawings and the appended claims.

### BRIEF DESCRIPTION OF THE DRAWINGS

FIG. 1 is a fragmentary perspective view of a motor vehicle body and a wheel assembly and incorporating a caliper brake cover constructed and installed in accordance with the invention;

FIG. 2 is a perspective view of the caliper brake cover shown in FIG. 1 and installed on a caliper brake and rotor assembly;

FIG. 3 is a downward view of the caliper brake housing and cover assembly shown in FIG. 2;

FIG. 4 is a perspective inner view of the caliper brake housing and cover assembly as shown in FIGS. 1-3;

FIG. 5 is a fragmentary radial section taken generally through a caliper brake and cover assembly as shown in FIGS. 2 & 3; and

FIG. 6 is a perspective view of a caliper brake cover constructed in accordance with another embodiment of the invention.

### DESCRIPTION OF THE PREFERRED EMBODIMENTS

FIG. 1 illustrates a motor vehicle 10 having a body 12 and a wheel assembly 15 including a rubber tire 17 mounted on a cast metal and chrome plated wheel 20 having circumferentially spaced openings 22 and 24 and a center portion enclosed by a wheel cover or hub cap 26. In a conventional manner, the center portion of the wheel assembly 15 mounts on an axle hub plate 28 having circumferentially spaced threaded bolts 31 which receive wheel nuts (not shown).

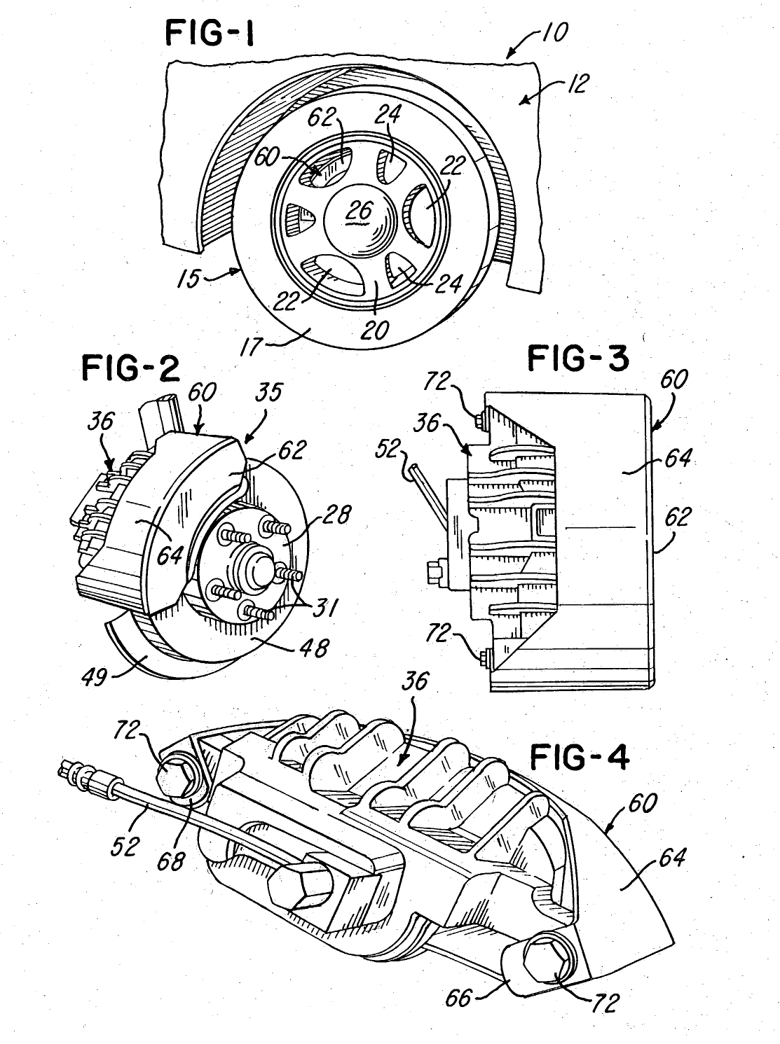

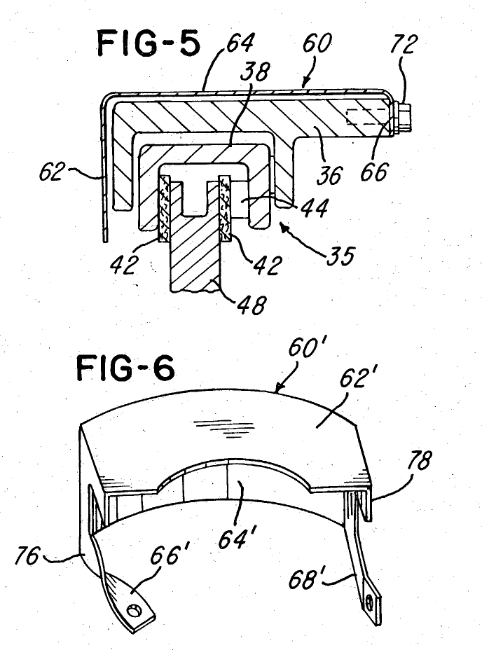

A conventional hydraulically actuated caliper brake assembly 35 includes a cast metal brake housing 36 supported by an axle enclosure of the vehicle 10. The housing 36 supports an arcuate bracket member 38 (FIG. 5) which carries a plurality of opposing brake pads 42 an set of hydraulic cylinders or actuators 44. A circular rotor disc 48 (FIGS. 2 & 5) is mounted for rotation with the axle hub 28 adjacent an inner cover plate 49 and rotates between the brake pads 42. The hydraulic cylinders 44 are actuated by high pressure hydraulic brake fluid supplied through a line 52 (FIG. 4) when it is desired to brake the vehicle by compressing each set of brake pads 42 against its corresponding rotor disc 48. The hydraulic caliper brake assembly 35 may have various forms depending upon the manufacturer of the brake assembly and the manufacturer of the motor vehicle.

In accordance with the present invention, a caliper brake cover 60 is formed of a rigid material and preferably as a stamping of aluminum sheet material. However, the cover 60 may also be formed as a thin walled metal die casting or of a molded plastic or composite material. As shown in FIGS. 2 and 3, the cover 60 includes a generally flat and arcuate radial front wall 62 which is integrally connected to a part-circular or arcuate outer rim wall 64. The cover 60 is positioned in covering relation to the brake caliper housing 36 so that the front wall 62 covers a front wall of the housing 36 and the outer rim wall 64 covers a portion of the radially outer wall of the housing 36. The cover 60 is supported in this position by a set or pair of rear tabs 66 and 68 (FIG. 4) which are formed as an integral part of the outer rim wall 64 and project inwardly from opposite end portions of the outer rim wall. The tabs 66 and 68 have holes for receiving threaded fasteners or machine screws 72 which are threaded into tapped holes within the metal brake caliper housing 36. The screws 72 are also used for mounting the brake caliper housing 36 onto the supporting structure for the housing. As apparent from FIG. 1, the flat front wall 62 of the cover 60 is exposed through the one or more of the openings 22 and 24 of the metal wheel 20 when the wheel is not rotating and blocks the view of the brake caliper housing 36.

The general shape of the caliper brake cover 60 is illustrated in FIGS. 2-4 and is formed according to the specific construction of the brake housing 36. However, it is to be understood that the cover 60 may have other forms and specific shapes depending upon the particular configuration and manufacturer of the caliper brake assembly. For example, a modified form of a caliper brake cover 60′ is shown in FIG. 6 and is adapted for use with another caliper brake assembly. In this embodiment, the cover 60′ includes a generally flat and arcuate front wall 62′ integrally connected to an arcuate outer rim wall 64′. The mounting and support tabs 66′ and 68′ project inwardly from opposite end portions of the outer rim wall 64′, and the cover 60′ also has opposite end wall portions 76 and 78. The tabs 66′ and 68′ are adapted to mount on components of the motor vehicle other than the brake housing 36, such as knuckles of the suspension system for the vehicle.

From the drawings and the above description, it is apparent that a caliper brake cover constructed in accordance with the invention, provides desirable features and advantages. As a primary advantage, the brake cover conceals the unattractive appearance of the caliper brake housing when viewed through the openings 22 and 24 of the wheel 20. Thus the cover is ideally suited for vehicles having cast metal decorative wheels having large circumferentially spaced openings. The cover may also be painted or powder coated to match the color of the vehicle body, and the front wall 62 of the cover 60 may carry a trademark or logo or a decorative design. The caliper brake cover of the invention does not block the flow of air through the wheel openings 22 and 24 and is effective to reduce brake dust from collecting on the wheel within the wheel openings. The cover may also be quickly attached to the caliper brake housing or a wheel suspension member. In addition, the cover 60 is effective to channel the flow of cooling air over the housing 36 and over the rotor disc 48 in response to rotation of the wheel for lowering the temperature of the housing and rotor disc.

While the forms of caliper brake cover herein described constitute preferred embodiments of the invention, it is to be understood that the invention is not limited to these precise forms of cover, and that changes may be made therein without departing from the scope and spirit of the invention as defined in the appended claims.

What is claimed is:

1. A caliper brake cover in combination with a caliper brake housing disposed in back of a decorative motor vehicle wheel having circumferentially spaced openings, said cover comprising a rigid body including a generally flat front wall, a laterally extending and generally arcuate outer rim wall rigidly connected to said front wall, support members projecting from said outer rim wall, and a set of fasteners releasably securing said support members to a component of said vehicle for positioning said front wall between said wheel and said caliper brake housing and for positioning said outer rim wall around said caliper brake housing to provide for enhancing the appearance of said caliper brake housing through said openings in said wheel and for a flow of cooling air through said openings and around said caliper brake housing and a rotor disc received within said housing.

2. A caliper brake cover as defined in claim 1 wherein said front wall and said outer rim wall and said support members comprise formed sheet metal.

3. A caliper brake cover as defined in claim 2 wherein said front wall, said outer rim wall and said support members comprise integrally connected portions of a single piece of said sheet metal.

4. A caliper brake cover as defined in claim 1 wherein said support members define openings for receiving threaded said fasteners.

5. A caliper brake cover as defined in claim 1 wherein said front wall, said outer rim wall and said support members are all integrally connected and comprise one piece of rigid material.

6. A caliper brake cover as defined in claim 1 wherein said support members project inwardly from opposite end portions of said outer rim wall.

7. A caliper brake cover as defined in claim 1 wherein said fasteners comprise threaded fasteners threaded into said caliper brake housing.

8. A caliper brake cover in combination with a caliper brake housing disposed in back of a decorative motor vehicle wheel having circumferentially spaced openings, said cover comprising a sheet metal body including a generally flat front wall, a laterally extending and generally arcuate outer rim wall integrally connected to said front wall, spaced support tabs projecting from said outer rim wall, and a set of threaded fasteners releasably securing said support tabs to a component of said vehicle for positioning said front wall between said wheel and said caliper brake housing and for positioning said outer rim wall around said caliper brake housing to provide for enhancing the appearance of said caliper brake housing through said openings in said wheel and for a flow of cooling air through said openings and around said caliper brake housing and a rotor disc received within said housing.

9. A caliper brake cover as defined in claim 8 wherein said front wall, said outer rim wall and said support tabs comprise integrally connected portions of a single piece of sheet metal.

10. A caliper brake cover as defined in claim 8 wherein said support tabs define holes for receiving said threaded fasteners.

11. A caliper brake cover as defined in claim 8 wherein said support tabs project inwardly from opposite end portions of said outer rim wall.

12. A caliper brake cover as defined in claim 8 wherein said threaded fasteners extend into an inner portion of said caliper brake housing.

13. A caliper brake cover adapted for use with a decorative motor vehicle wheel having circumferentially spaced openings, said cover comprising a rigid body including a generally flat front wall, a laterally extending and generally arcuate outer rim wall rigidly connected to said front wall, and support members projecting from said outer rim wall for releasably securing said support members to a component of said vehicle for positioning said front wall between said wheel and a caliper brake housing to provide for enhancing the appearance of said caliper brake housing through said openings in said wheel.

14. A caliper brake cover as defined in claim 13 wherein said front wall and said outer rim wall and said support members comprise formed sheet metal.

15. A caliper brake cover as defined in claim 14 wherein said front wall, said outer rim wall and said support members comprise integrally connected portions of a single piece of said sheet metal.

16. A caliper brake cover as defined in claim 13 wherein said support members define openings for receiving threaded said fasteners.

17. A caliper brake cover as defined in claim 13 wherein said front wall, said outer rim wall and said support members are all integrally connected and comprise one piece of rigid material.

18. A caliper brake cover as defined in claim 13 wherein said support members project inwardly from opposite end portions of said outer rim wall.
